(19) United States
(12) Patent Application Publication
(10) Pub. No.: US 2025/0184954 A1
(43) Pub. Date: Jun. 5, 2025

(54) METHOD AND APPARATUS FOR UPDATING DATABSE OF NETWORK ACCESS POINT LOCATION

(71) Applicant: HERE GLOBAL B.V., EINDHOVEN (NL)

(72) Inventors: PAVEL IVANOV, TAMPERE (FI); LAURI AARNE JOHANNES WIROLA, TAMPERE (FI); MARKO LUOMI, TAMPERE (FI); HENRI NURMINEN, TAMPERE (FI)

(73) Assignee: HERE GLOBAL B.V., EINDHOVEN (NL)

(21) Appl. No.: 18/523,948

(22) Filed: Nov. 30, 2023

(51) Int. Cl. H04W 64/00

(52) U.S. Cl. CPC H04W 64/003

(57) ABSTRACT

A method and an apparatus for updating database of network access point location are provided. The apparatus identifies a network access point accessible to a mobile apparatus and receives network access point information of the network access point. The apparatus receives a single-sided round-trip time (RTT) measurement of the network access point. The network access point information comprises identification data and a first signal strength value, and the single-sided RTT measurement comprises a second signal strength value. The apparatus scales the second signal strength value based on the first signal strength value. The apparatus updates the database of network access point location based on the scaled second signal strength value.

### TECHNOLOGICAL FIELD

An example embodiment relates to generating databases of network access point location comprising location and signal matching corresponding to network access points. An example embodiment relates to updating and using the databases of network access point location for position estimations of mobile apparatuses.

### BACKGROUND

Radio-based positioning technology may generate and use global databases based on crowd-sourced information. For example, the crowd-sourced information may indicate observations of radio signals of radio network access points in a radio environment. To this end, a network positioning system relies on mobile apparatuses collecting information about surrounding radio networks.

In order to send crowd-sourced information to the network positioning system, a mobile apparatus may need to perform radio measurements to collect different parameters of a radio network. However, the mobile apparatus may have limitations owing to their battery life and power consumption. Due to battery limitations, certain hardware and/or software limitation may need to be applied for performing the radio measurements. This may hinder continuous and reliable values of radio measurements and may further affect accuracy and reliability of the global databases.

### BRIEF SUMMARY

Various embodiments provide methods, systems, and computer program products for generating, updating, and/or using a global database of network access point location. For example, the database of network access point location is generated and/or updated based on crowd-sourced information received from multitude of mobile apparatuses. For example, the database of network access point location may store a mapping between a signal space and a location space of a network access point for position estimation use.

Network positioning systems, such as cellular and non-cellular positioning systems rely on generating large global databases comprising information associated with cellular and non-cellular signals. The global databases may be generated based on crowd-sourced data from mobile apparatuses utilizing the network positioning systems, i.e., users of the network positioning systems.

In various embodiments, data collected or crowd-sourced from the mobile apparatuses are in the form of fingerprints. For example, fingerprints may include location references or location information of the mobile apparatuses, time stamps and radio measurements associated with a network access point of a radio network. For example, crowd-sourced data associated with the network access point received from multitude of mobile apparatuses may be stored within a database of network access point location on a server or a cloud.

In an example embodiment, certain processing may be performed on the crowd-sourced data to generate models of the network access point. For example, a model of the network access point may comprise a mapping relationship between a signal space and a location space of the network access point.

In various embodiments, the model of the radio node and/or its derivative may be transferred back to a mobile apparatus for use in position determination. For example, a network positioning system may utilize the model indicating, for example, network access point location, network access point coverage area and/or or signal strength map of the network access point, to determine an estimate of location of the mobile apparatus.

According to an aspect of the present disclosure, a method for updating and/or using a database of network access point location is provided. In an example embodiment, the method comprises identifying, by a network apparatus, a network access point accessible to a mobile apparatus. The method further comprises receiving, by the network apparatus, network access point information associated with the network access point. The network access point information comprises at least: identification data and a first signal strength value. The method further comprises receiving, by the network apparatus, a single-sided round-trip time (RTT) measurement associated with the network access point. The single-sided RTT measurement comprises at least a second signal strength value. The method further comprises scaling, by the network apparatus, the second signal strength value based on the first signal strength value; and updating, by the network apparatus, a database of network access point location based on the scaled second signal strength value. In an example, each of the first signal strength value and the second signal strength value comprises at least a received signal strength indicator (RSSI) measurement.

In an example embodiment, the method further comprises receiving, by the network apparatus, the network access point information at a beginning of a first time interval; receiving, by the network apparatus, the single-sided round-trip time (RTT) measurement associated with the network access point during the first time interval; and determining, by the network apparatus, location information for the mobile apparatus during the first time interval based on the network access point information and the single-sided RTT measurement.

In an example embodiment, the method further comprises determining, by the network apparatus, a ratio of the first signal strength value and the second signal strength value; and determining, by the network apparatus, a product of the determined ratio and the second signal strength value.

In an example embodiment, the method further comprises generating, by the network apparatus, a radio model for the network access point based on the scaled second signal strength value and the first signal strength value of the network access point; and transmitting, by the network apparatus, the radio model to the mobile apparatus for position estimation.

In an example embodiment, the method further comprises causing, by the network apparatus, the mobile apparatus to estimate the location information based on at least one of: the radio model, or the updated database of network access point location.

In an example embodiment, for identifying the network access point, the method further comprises causing to perform, by the network apparatus using a first scanning module of the mobile apparatus, a first scan across a plurality of frequency channels to identify the network access point accessible to the mobile apparatus.

In an example embodiment, for receiving the single-sided RTT measurement, the method further comprises causing to perform, by the network apparatus using a second scanning module of the mobile apparatus, a second scan for the network access point after the first scan; and receiving, by the network apparatus, the single-sided RTT measurement associated with the network access point based on the ranging request. The second scan comprises sending a ranging request across a frequency channel associated with the network access point.

In an example embodiment, the method further comprises determining, by the network apparatus, a reference location for the mobile apparatus; estimating, by the network apparatus, a historical location associated with the network access point; estimating, by the network apparatus, a turnaround time for the network access point based on the reference location, the historical location and a time value associated with the ranging request for the single-sided RTT measurement; and receiving, by the network apparatus, the single-sided RTT measurement associated with the network access point using the estimated turnaround time for the network access point.

In an example embodiment, the method further comprises causing to perform, by the network apparatus, the first scan using a Wi-Fi scanning module of the mobile apparatus; and causing to perform, by the network apparatus, the second scan using a Wi-Fi single-sided RTT scanning module. The Wi-Fi scanning module is configured to perform the first scan based on a predefined throttling period. The Wi-Fi single-sided RTT scanning module is configured to send the ranging request based on a predefined ranging period, and wherein the predefined ranging period is less than the predefined throttling period.

In an example embodiment, the method further comprises causing to perform, by the network apparatus using the first scanning module, a plurality of first scans based on a predefined throttling period; and causing to perform, by the network apparatus using the second scanning module, one or more second scans across the frequency channel associated with the network access point. The plurality of first scans comprise the first scan performed across the plurality of frequency channels to identify the network access point. The one or more second scans are performed between two consecutive first scans from the plurality of first scans, and each of the one or more second scans is performed once in every predefined time period. The predefined time period lies within the predefined throttling period.

In an example embodiment, the method further comprises causing, by the network apparatus, the mobile apparatus to determine battery information of the mobile apparatus. The battery information indicates at least a battery charge value. The method further comprises causing, by the network apparatus, the mobile apparatus to perform radio measurements based on the plurality of first scan and the one or more second scans based on a determination of the battery charge value to be less than a predefined charge threshold.

In an example embodiment, the method further comprises identifying, by the network apparatus, a plurality of available network access points accessible to the mobile apparatus; receiving, by the network apparatus, network access point information associated with each of the plurality of available network access points; selecting, by the network apparatus, the network access point for the mobile apparatus based on a set of predefined selection criteria; and after selection, receiving, by the network apparatus, the single-sided RTT measurement associated with the network access point. The plurality of available network access points comprises the network access point. The network access point information comprises at least: identification data and first signal strength value data.

In an example embodiment, the database of network access point location is a radio map associated with the network access point, and wherein the radio map comprises one or more access point models associated with the network access point.

According to another aspect, an apparatus is provided. In an example embodiment, the apparatus comprises at least one processor and at least one memory storing computer program code and/or instructions. The at least one memory and the computer program code is configured to, with the processor, cause the apparatus to identify a network access point accessible to a mobile apparatus; receive network access point information associated with the network access point, wherein the network access point information comprises at least: identification data and a first signal strength value; receive a single-sided round-trip time (RTT) measurement associated with the network access point, wherein the single-sided RTT measurement comprises at least a second signal strength value; scale the second signal strength value based on the first signal strength value, wherein each of the first signal strength value and the second signal strength value comprises at least a received signal strength indicator (RSSI) measurement; and update a database of network access point location based on the scaled second signal strength value.

In an example embodiment, the at least one memory and the computer program code is configured to, with the processor, further cause the apparatus to determine a ratio of the first signal strength value and the second signal strength value; and determine a product of the determined ratio and the second signal strength value.

In an example embodiment, the at least one memory and the computer program code is configured to, with the processor, further cause the apparatus to generate a radio model for the network access point based on the scaled second signal strength value and the first signal strength value of the network access point; and transmit the radio model to the mobile apparatus for position estimation.

In an example embodiment, the at least one memory and the computer program code is configured to, with the processor, further cause the apparatus to cause to perform, using a first scanning module of the mobile apparatus, a first scan across a plurality of frequency channels; identify a plurality of available network access points accessible to the mobile apparatus, wherein the plurality of available network access points comprise the network access point; receive network access point information associated with each of the plurality of available network access points, wherein the network access point information comprises at least: identification data and first signal strength value data; and select the network access point for the mobile apparatus based on a set of predefined selection criteria. The at least one memory and the computer program code is configured to, with the processor, further cause the apparatus to cause to perform, using a second scanning module of the mobile apparatus, a second scan for the network access point after the first scan, wherein the second scan comprises sending a ranging request across a frequency channel associated with the network access point; and receive the single-sided RTT measurement associated with the network access point based on the ranging request.

In an example embodiment, the at least one memory and the computer program code is configured to, with the processor, further cause the apparatus to cause to perform the first scan using a Wi-Fi scanning module of the mobile apparatus, wherein the Wi-Fi scanning module is configured to perform the first scan based on a predefined throttling period; and cause to perform the second scan using a Wi-Fi single-sided RTT scanning module, wherein the Wi-Fi single-sided RTT scanning module is configured to send the ranging request based on a predefined ranging period, and wherein the predefined ranging period is less than the predefined throttling period.

In an example embodiment, the at least one memory and the computer program code is configured to, with the processor, further cause the apparatus to cause to perform, using the first scanning module, a plurality of first scans based on a predefined throttling period; and cause to perform, using the second scanning module, one or more second scans across the frequency channel associated with the network access point. The plurality of first scans comprise the first scan performed across the plurality of frequency channels to identify the network access point. The one or more second scans are performed between two consecutive first scans from the plurality of first scans, and each of the one or more second scans is performed once in every predefined time period. The predefined time period lies within the predefined throttling period.

In an example embodiment, the at least one memory and the computer program code is configured to, with the processor, further cause the apparatus to cause the mobile apparatus to determine battery information of the mobile apparatus, the battery information indicating at least a battery charge value; and cause the mobile apparatus to perform radio measurements based on the plurality of first scans and the one or more second scans based on determination of the battery charge value to be less than a predefined charge threshold.

### BRIEF DESCRIPTION OF THE DRAWINGS

Having thus described certain example embodiments in general terms, reference will hereinafter be made to the accompanying drawings, which are not necessarily drawn to scale, and wherein:

FIG. 1 is a block diagram showing an example system of one embodiment of the present disclosure;

FIG. 2A is a block diagram of a network apparatus that may be specifically configured in accordance with an example embodiment;

FIG. 2B is a block diagram of a mobile apparatus that may be specifically configured in accordance with an example embodiment;

FIG. 3 is a flowchart illustrating operations performed, such as by the mobile apparatus of FIG. 2B, for performing radio measurements using different sources, in accordance with an example embodiment;

FIG. 4 is a flowchart illustrating operations performed, such as by the mobile apparatus of FIG. 2B, for performing radio measurements based on battery information, in accordance with an example embodiment;

FIGS. 5A and 5B collectively illustrate a sequence diagram that depicts operations performed, such as by the mobile apparatus of FIG. 2B and the network apparatus of FIG. 2A, to update the database of network access point location, in accordance with an example embodiment;

FIG. 6 illustrates a graphic representation of scaling of a single-sided RTT measurement, in accordance with an example embodiment;

FIG. 7 is a flowchart illustrating operations performed, such as by the network apparatus of FIG. 2A, for scaling single sided RTT measurements to update the database of network access point location, in accordance with an example embodiment;

FIG. 8 is a flowchart illustrating operations performed, such as by the network apparatus of FIG. 2A, to receive the single-sided RTT measurements, in accordance with an example embodiment; and

FIG. 9 is a flowchart illustrating operations performed, such as by the network apparatus of FIG. 2A, for updating the database of network access point location, in accordance with an example embodiment.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. Like reference numerals refer to like elements throughout. As used herein, the terms “data,” “content,” “information,” and similar terms may be used interchangeably to refer to data capable of being transmitted, received and/or stored in accordance with embodiments of the present invention. As used herein, the terms “substantially” and “approximately” refer to values and/or tolerances that are within manufacturing and/or engineering guidelines and/or limits. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware.

Various embodiments provide method and apparatus for updating and/or using a database of network access point location. For example, the database of network access point location may be a radio map corresponding to a network access point. The radio map may comprise one or more radio models indicating mapping relationship between signal space and location space of the network access point from being used for radio-based positioning. The radio map or the database may be generated based on crowd-sourced data from multitude of mobile apparatuses.

For example, data from a mobile apparatus may be in form of fingerprints that may include a location reference, time stamps and radio measurements taken from a radio interface (such as, cellular interface, Wi-Fi interface, Bluetooth Low Energy (BLE) interface, ultra-wideband (UWB) interface, etc.). In an example, the radio measurements collected using the cellular interface may include, for example, global and/or local IDs of observed cellular network cells, signal strength of the observed cellular network cells, path loss estimates of the observed cellular network cells, and timing measurements (measured as, for example, timing advance or round-trip time (RTT)). In another example, the radio measurements collected using the Wi-Fi interface may include, for example, MAC address of the air interface (namely, basic service set identifiers (BSSIDs)) of observed WLAN access points, service set identifiers (SSIDs) of the observed WLAN access points, signal strengths of the observed WLAN access points (measured as, for example, received signal strength index (RSSI) measurement, physical Rx level in dBm referenced to one milliwatt (mW), etc.), path loss estimates of the observed WLAN access points and timing measurements (measured as, for example, RTT). In certain cases, the radio measurements collected by a mobile apparatus may also include measurements relating to the environment, such as magnetic field measurements.

The data collected by the mobile apparatus may be uploaded to a server or accessed by a network apparatus that may perform certain operations on the collected data to generate a radio model of the network access point, i.e., a communication node in a radio environment. The radio model of the network access point may indicate mapping relationships based on, for example, coverage areas, network access point position or location, radio propagation model, Rx field, etc. In accordance with an embodiment, databases of network access point locations of network access points may form the radio map. The radio map may include a collection of radio models associated with the network access points.

To this end, the radio model or its derivatives may be transferred back to the mobile apparatus for use in position determination. In an example, a network positioning system may use the database of the network access point location indicating for example, location, coverage areas and/or signal strength map to estimate of location or position of the mobile apparatus.

To this end, building the network positioning system also relies on data associated with radio networks collected by mobile apparatuses. In an example embodiment, a mobile apparatus, when moving, may need to perform radio measurements for prolonged time in order to collect different parameters of one or more network access points of the radio network. For example, accuracy of one or more models of the one or more network access points may be dependent on quality of the radio measurements collected by the mobile apparatuses.

In an example embodiment, the mobile apparatus may have limitations due to battery life and power consumption. Therefore, there may be software and/or hardware limitations on a manner in which the mobile apparatus collects the radio measurements. For example, the limitations may be on how often or frequently the mobile apparatus may collect the radio measurements, or how long the collected radio measurements may be used for position estimation.

In an example, the radio measurements may be collected using a Wi-Fi interface. In such a case, due to battery life and power consumption limitations of the mobile apparatus, radio measurements may be collected through Wi-Fi scan throttling. In this regard, when Wi-Fi scan throttling is enabled, the mobile apparatus may perform Wi-Fi scans for collecting radio measurements only four times in two minutes. In other words, a maximum of one Wi-Fi scan may be performed every thirty seconds. To this end, if a user using the mobile apparatus is walking, then a location of the mobile device may change by a few meters, say 20-40 meters. Alternatively, if the user using the mobile apparatus is driving or travelling in a vehicle, then a location of the mobile apparatus or a distance of the mobile apparatus from a network access point may change considerably. For example, if the user is travelling at a speed of 50-60 kilometer per hour (kph), a change in distance may be in order of hundreds, specifically, 400-500. At higher speed, this change in distance may increase further. Therefore, such incomplete data and radio measurements may pose a challenge for generating reliable radio map data as well as for the network positioning system. For example, for data collection or for updating databases of network access point location and position estimation, the radio measurements may have an offset thereby generating inaccurate result.

Conventional network positioning systems may employ certain sensor-based position estimation technologies in addition to the network positioning system to fill in the gaps due to irregular collection of radio measurements by the mobile apparatus when using the network positioning system. However, such sensor-based position estimation technologies may require specialized sensors that may not be present in some cases. Moreover, the readings of the sensor may be inaccurate and its use to fill gaps of the network positioning system may lead to inaccurate position determination. Therefore, technical problems exist regarding generating radio maps or databases of network access point locations for use with radio-based positioning techniques.

Various embodiments provide technical solutions to these technical problems. For example, mobile apparatuses may use different sources of radio measurements available in the mobile apparatuses for the data collection phase as well as for the positioning phase. The measurements from the different sources may not have the same timing and scaling and therefore such measurements may be useful in identifying continuous change in radio measurements for accurate position estimation.

Thus, various embodiments provide improvements to the fields of radio map generation and radio-based positioning. The database of network access point location may be used to improve quality of positioning estimates determined by network positioning system. The various embodiments may enable providing more radio measurements as input to the database to improve accuracy of the database and more frequent positioning estimation for the mobile apparatuses. Therefore various embodiments provide improved user experience and improved computer apparatus performance.

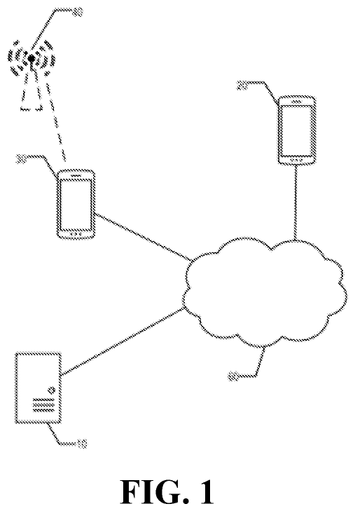

FIG. 1 provides an illustration of an example system that can be used in conjunction with various embodiments of the present invention. As shown in FIG. 1, the system includes one or more network apparatuses (depicted as network apparatus 10), one or more mobile apparatuses (depicted as mobile apparatus 20), one or more computing apparatuses (depicted as computing apparatus 30), one or more networks (depicted as network 60), and/or the like. In an example embodiment, the system includes one or more radio network access points, depicted as a network access point 40. In an example embodiment, the network apparatus 10 is a server, group of servers, distributed computing system, part of a cloud-based computing system, and/or other computing system. In various embodiments, the mobile apparatus 20 and/or the computing apparatus 30 is a smart phone, tablet, laptop, personal digital assistant (PDA), mobile computing device, navigation system, vehicle control system (e.g., ADAS or automated vehicle control system), mobile data gathering platform and/or the like. For example, the mobile apparatus 20 and/or the computing apparatus 30 is a vehicle control system configured to autonomously drive a vehicle, assist in control of a vehicle, monitor various aspects of the vehicle (e.g., fault conditions, motor oil status, battery charge level, fuel tank fill level, and/or the like) and/or the like. In various embodiments, the mobile apparatus 20 and/or the computing apparatus 30 is configured to autonomously drive a vehicle and may perform multiple functions that are similar to those performed by the mobile apparatus 20 and/or the computing apparatus 30 configured to be an automated driver assistance system (ADAS) (e.g., lane keeping, lane change assistance, maintaining a lane, merging, etc.). In an example embodiment, the mobile apparatus 20 and/or the computing apparatus 30 is configured to perform one or more positioning and/or navigation-related functions.

In various embodiments, the system further includes the network access point 40. In various embodiments, the network access point 40 is a wireless network access point and/or gateway such as Wi-Fi network access point, cellular network access point, Bluetooth access point, and/or other radio frequency-based network access point. For example, in various embodiments, the mobile apparatus 20 and/or the computing apparatus 30 capture data corresponding to observations of radio frequency signals emitted, transmitted, and/or broadcast by the network access point 40 within the environment and/or proximity of the mobile apparatus 20.

In various embodiments, the network apparatus 10 communicates with the one or more mobile apparatus 20 and/or the one or more computing apparatus 30 via the wired or wireless network 60. In various embodiments, the network access point 40 is a wireless access point that may be used by the mobile apparatus 20 and/or the computing apparatus 30 to communicate with the network 60. In various embodiments, the network access point 40 need not be an access point for accessing the network 60.

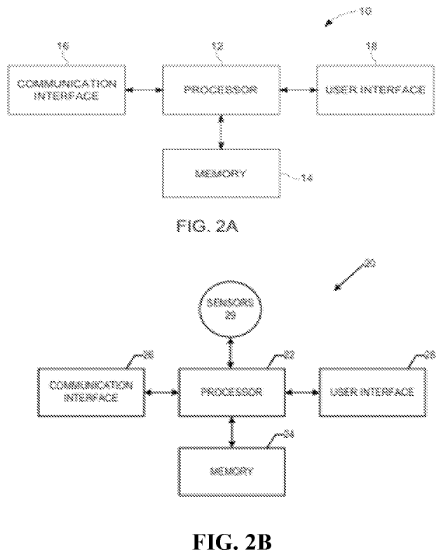

In an example embodiment, a network apparatus 10 may comprise components similar to those shown in the example network apparatus 10 diagrammed in FIG. 2A. In an example embodiment, the network apparatus 10 is configured to receive network access point information and single-sided RTT measurement from different sources of radio measurements; scale the measurements received from the different sources and update a database of network access point location based on scaled measurements. The network apparatus 10 is also configured provide the database of network access point location or a radio map for use in performing radio-based positioning, navigation-related functions, and/or the like.

For example, as shown in FIG. 2A, the network apparatus 10 may comprise a processor 12, memory 14, a user interface 18, a communication interface 16, and/or other components configured to perform various operations, procedures, functions, or the like described herein. In various embodiments, the network apparatus 10 stores a geographical database, digital map, and/or database of network access point location or positioning map, such as a radio map (e.g., a compilation and/or aggregation of respective radio models for a plurality of radio network access points, a radio environment and/or cellular network access point positioning map, and/or an access point registry); computer program code and/or instructions for performing various functions described herein; and/or the like (e.g., in memory 14), for example. In at least some example embodiments, the memory 14 is non-transitory.

In an example embodiment, the mobile apparatus 20 is configured and/or programmed for use as a radio network access point. In an example embodiment, the mobile apparatus 20 is a mobile computing device such as a smartphone, tablet, laptop, PDA, navigation system, vehicle control system, an Internet of things (IoT) device, and/or the like. In an example embodiment, as shown in FIG. 2B, the mobile apparatus 20 may comprise a processor 22, memory 24, a communication interface 26, a user interface 28, one or more sensors 29 and/or other components configured to perform various operations, procedures, functions or the like described herein. In various embodiments, the mobile apparatus 20 stores at least a portion of one or more digital maps (e.g., geographic databases, positioning maps, and/or the like) and/or computer executable instructions for collecting and/or storing radio measurements using different sources, and/or the like in memory 24. In at least some example embodiments, the memory 24 is non-transitory.

In various embodiments, the sensors 29 comprise one or more IMU sensors, one or more GNSS sensors, one or more radio sensors, and/or other sensors. In an example embodiment, the one or more IMU sensors comprise one or more accelerometers, gyroscopes, magnetometers, and/or the like. In various embodiments, the one or more GNSS sensor(s) are configured to communicate with one or more GNSS satellites and determine GNSS-based position estimates and/or other information based on the communication with the GNSS satellites. In various embodiments, the one or more radio sensors comprise one or more radio interfaces configured to observe and/or receive signals generated and/or transmitted by one or more access points and/or other computing entities (e.g., the network access point 40). For example, the one or more interfaces may be configured (possibly in coordination with processor 22) to determine a locally unique identifier, globally unique identifier, and/or operational parameters of the network access point 40 observed by the radio sensor(s) (e.g., observed signal strength, round-trip time, timing advance, and/or the like). As used herein, a radio sensor observes the network access point 40 by receiving, capturing, measuring and/or observing a (radio frequency) signal generated and/or transmitted by the network access point 40. In an example embodiment, the interface of a radio sensor may be configured to observe one or more types of signals such as generated and/or transmitted in accordance with one or more protocols such as 5G, general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. For example, the interface of a radio sensor may be configured to observe signals of one or more modern global cellular formats such as GSM, WCDMA, TD-SCDMA, LTE, LTE-A, CDMA, NB-IoT and/or non-cellular formats such as WLAN, Bluetooth, Bluetooth Low Energy (BLE), Zigbee, Lora, and/or the like. For example, the interface(s) of the radio senor(s) may be configured to observe radio, millimeter, microwave, and/or infrared wavelength signals. In an example embodiment, the interface of radio sensor may be coupled to and/or part of a communication interface 26. In various embodiments, the sensors 29 may further comprise one or more image sensors configured to capture visual samples, such as digital camera(s), 3D cameras, 360° cameras, and/or image sensors. In various embodiments, the one or more sensors 29 may comprise various other sensors such as two dimensional (2D) and/or three dimensional (3D) light detection and ranging (LiDAR) (s), long, medium, and/or short range radio detection and ranging (RADAR), ultrasonic sensors, electromagnetic sensors, (near-) infrared (IR) cameras.

In an example embodiment, the computing apparatus 30 is configured to obtain the database of network access point location, perform radio-based positioning using the database, and/or the like. In various embodiments, the database or the radio map may be used to perform one or more positioning and/or navigation-related functions. Some non-limiting examples of positioning and/or navigation-related functions include providing a route or information corresponding to a geographic area (e.g., via a user interface), localization, localization visualization, route determination, lane level route determination, operating a vehicle along at least a portion of a route, operating a vehicle along at least a portion of a lane level route, route travel time determination, lane maintenance, route guidance, lane level route guidance, provision of traffic information/data, provision of lane level traffic information/data, vehicle trajectory determination and/or guidance, vehicle speed and/or handling control, route and/or maneuver visualization, and/or the like.

In an example embodiment, the computing apparatus 30 is a mobile computing device such as a smartphone, tablet, laptop, PDA, navigation system, vehicle control system, an Internet of things (IoT) device, and/or the like. In an example embodiment, the computing apparatus 30 is a mobile apparatus 20. In an example embodiment, the computing apparatus 30 may comprise a processor, memory, a communication interface, a user interface, one or more sensors and/or other components configured to perform various operations, procedures, functions or the like described herein. In various embodiments, the computing apparatus 30 stores at least a portion of one or more digital maps (e.g., geographic databases, positioning maps, and/or the like), a database of network access point location, and/or computer executable instructions for generating and/or using instances of crowd-sourced data, and/or the like in memory. In at least some example embodiments, the memory is non-transitory.

Each of the components of the system may be in electronic communication with, for example, one another over the same or different wireless or wired networks, such as the network 60 including, for example, a wired or wireless Personal Area Network (PAN), Local Area Network (LAN), Metropolitan Area Network (MAN), Wide Area Network (WAN), cellular network, and/or the like. In an example embodiment, the network 60 comprises the automotive cloud, digital transportation infrastructure (DTI), radio data system (RDS)/high definition (HD) radio or other digital radio system, and/or the like. For example, the mobile apparatus 20 and/or the computing apparatus 30 may be in communication with a network apparatus 10 via the network 60. For example, the mobile apparatus 20 and/or the computing apparatus 30 may communicate with the network apparatus 10 via a network, such as the Cloud. For example, the Cloud may be a computer network that provides shared computer processing resources and data to computers and other devices connected thereto. For example, the mobile apparatus 20 generates an identifier communication and provides (e.g., transmits) the identifier communication such that the network apparatus 10 receives the identifier communication via the network 60. For example, the network apparatus 10 generates and/or updates a repository of mobile apparatus identifiers and provides (e.g., transmits) the repository of mobile apparatus identifiers such that the computing apparatus 30 receives the repository of mobile apparatus identifiers via the network 60.

Certain example embodiments of the network apparatus 10, the mobile apparatus 20, and the computing apparatus 30 are described in more detail below with respect to FIGS. 2A and 2B.

In various embodiments, a mobile apparatus 20 collects or performs and provides radio measurements. In various embodiments, the mobile apparatus 20 may determine that it requires to use the network positioning system, such as for navigation, and responsive thereto, collects and provides the radio measurements to the network apparatus 10. For example, the mobile apparatus 20 may use different sources of radio measurements to collect the radio measurements.

In various embodiments, the network apparatus 10 obtains (e.g., receives via communication interface 16 and/or accesses from memory 14) radio measurements from the mobile apparatus 20 that may be collected via different sources. The network apparatus 10 processes the received radio measurements to scale the radio measurements collected through the different sources. The scaled radio measurements may be stored and used to update a database of network access point location, or a radio map associated with the network access point. The network apparatus 10 may then be configured to generate a radio model of the network access point based on the scaled radio measurements. The radio model may be communicated to the respective mobile apparatus 20 via a respective radio network for position estimation.

### Exemplary Operation of a Mobile Apparatus

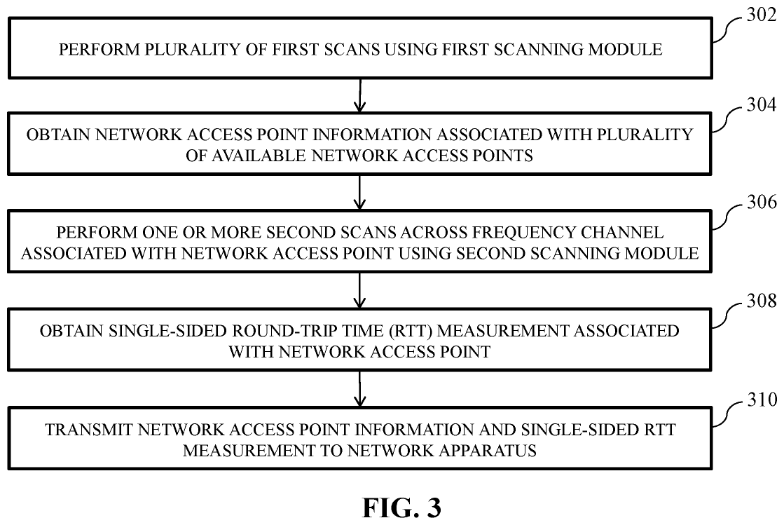

FIG. 3 provides a flowchart illustrating various processes, procedures, operations, and/or the like for performing radio measurements using different sources by the mobile apparatus 20, according to an example embodiment. In various embodiments, the mobile apparatus 20 may perform the processes, procedures, and/or operations illustrated in FIG. 3 upon a first start-up and/or boot-up of the mobile apparatus 20, on each start-up and/or boot-up of the mobile apparatus 20, initialization and/or a first execution of a particular program (e.g., a crowd-sourcing client program, a network positioning program, a navigation program, and/or the like), periodically and/or regularly, and/or the like.

At step 302, the mobile apparatus 20 is configured to perform a plurality of first scans using a first scanning module. The plurality of first scans may be performed periodically. For example, the plurality of first scans is performed based on the predefined throttling period. In an example, each of the plurality of first scans may be performed across a plurality of frequency channels at a corresponding particular time. For example, the first scanning module of the mobile apparatus 20 may perform a first scan from the plurality of first scans at a particular time across a plurality of frequency channels. Based on the first scan, a plurality of available network access points accessible to the mobile apparatus 20 at the particular time may be identified. For example, the plurality of available network access points may include the network access point 40 accessible to the mobile apparatus 20.

In an example, the mobile apparatus 20 may be configured to collect radio measurements for a Wi-Fi interface. In such a case, the first scan, i.e., a first type of radio measurement, may be performed using a Wi-Fi scanning module of the mobile apparatus 20. it may be noted that the Wi-Fi scanning module may have a predefined throttling period. In particular, the predefined throttling period defines a maximum number of times that the Wi-Fi scanning module may perform a scanning function over a period of time. For example, the Wi-Fi scanning module may have the predefined throttling period of four scans in two minutes, i.e., one scan in every thirty seconds. To this end, the plurality of first scans may be performed based on the predefined throttling period, i.e., once in every thirty second. It may be noted that collecting the radio measurements for the Wi-Fi interface is only exemplary and should not be construed as a limitation. In another example, the mobile apparatus 20 may be configured to perform radio measurements for a cellular network interface, UWB network interface, BLE network interface, etc.

For example, the Wi-Fi scanning module performs scanning across the plurality of frequency channels based on the predefined throttling period, i.e., once in every thirty seconds or four times in every two minutes. To this end, if only radio measurements after the first scan at the particular time may be considered for position estimation for the next thirty seconds, this may lead to inaccuracy in position estimation. To overcome this drawback and improve accuracy of position estimation while conserving battery life of the mobile apparatus 20, different sources are used for performing the radio measurements.

At step 304, the mobile apparatus 20 is configured to obtain (such as receive or access from a memory associated with the network access points) network access point information associated with the plurality of available network access points. For example, the network access point information comprises at least: identification data and a first signal strength value associated with corresponding plurality of available network access points. In accordance with an example, the identification data for a network access point includes, for example, MAC address, global identifier, local identifier, SSID, BSSID, etc. In addition, the first signal strength value associated with the network access point may include a signal strength measurement, such as an RSSI measurement (referred to as RSSI1) for radio signal from the network access point.

It may be noted that a time at which the first scanning module may perform the first scan to obtain the network access point information may correspond to a beginning of a first time interval. In particular, during the duration of the first time interval, the first scanning module may be operational only once, i.e. at the beginning of the first time interval. For example, the duration of the first time interval may rely on the predefined throttling period of the first scanning module, i.e., the first time interval may be thirty seconds long. To that end, once the first scan is performed at the beginning of the first interval, such first scan may not be performed over the course of the first time interval. Moreover, a subsequent first scan may be performed after the first time interval is over marking a beginning of another time interval.

According to various embodiments, the network access point information associated with the plurality of available network access points is obtained or accessed and transmitted to the network apparatus 10. For example, the network apparatus 10 may select a particular network access point, such as the network access point 40, from the plurality of available network access points for further processing. In an example, the network apparatus 10 may select the network access point 40 for further processing based on a set of predefined selection criteria.

Continuing further, at step 306, the mobile apparatus is configured to perform one or more second scans across the frequency channel associated with the network access point 40 using a second scanning module. In an example, the one or more second scans may be performed after the first scan for a frequency channel associated with the network access point 40.

It may be noted that the second scanning module is different from the first scanning module. To this end, data collected using the one or more second scans may not be comparable with respect to radio measurements collected using the first scan. For example, the data collected using the one or more second scans may be used to fill gaps due to irregular data collected using the first scan.

In an example, the mobile apparatus 20 may be configured to collect radio measurements for the Wi-Fi interface. In such a case, the second scan, i.e., a second type of radio measurement, may be performed using a Wi-Fi single-sided RTT scanning module of the mobile apparatus 20. The Wi-Fi single-sided RTT scanning module is configured to perform the one or more second scans by sending a ranging request across the frequency channel associated with the network access point 40.

As described above, the Wi-Fi scanning module for performing the plurality of first scans may have the predefined throttling period of four scans in every two minutes, i.e., one scan in every thirty seconds. Subsequently, the Wi-Fi single-sided RTT scanning module may be configured to perform one or more second scans within the thirty seconds in which the Wi-Fi scanning module is not operational. To this end, the one or more second scans may be performed between two consecutive first scans from the plurality of first scans. In other words, the one or more second scans may be performed during a time period when the first scanning module is not operational, i.e., not scanning during predefined throttling period. This may ensure that data is collected from the network access point 40 more frequently, without burdening the battery of the mobile apparatus 20. In addition, such frequently collected data enables to improve positioning quality for network positioning system by providing more radio data as input to a learning phase and enabling more frequent positioning estimation in a positioning phase.

Similar to the plurality of first scans, the one or more second scans may also be performed periodically. Particularly, each of the one or more second scans is performed once in every predefined time period. For example, the predefined time period for the second scans may be one second. In such a case, the Wi-Fi single-sided RTT scanning module may perform the second scans once every second. Moreover, the Wi-Fi single-sided RTT scanning module may perform the second scans across the frequency channel of the network access point 40 selected after the first scan, such that the second scans may be performed once in every one second during the duration of the first time interval.

To this end, the different sources of performing radio measurements, such as the first scanning module or the Wi-Fi scanning module and the second scanning module or the Wi-Fi single-sided RTT scanning module may complement each other. The first scan may be required to know plurality of access points that may be available or reachable for the mobile apparatus 20, and the second scans during the first time interval may be required to collect radio measurements continuously for improving accuracy. The second scans may consume less energy than the first scan because the second scans may not scan different frequency channels, but only the frequency channel of the selected network access point 40.

To this end, a time interval between two consecutive second scans, i.e., the predefined time period, is less than a time interval between two consecutive first scans, i.e., the predefined throttling period. Moreover, the predefined time period lies within the predefined throttling period. In particular, the one or more second scans may be performed within the first time interval that is initiated by the first scan and during which the first scan is not being performed.

At step 308, the mobile apparatus 20 is configured to obtain (such as receive or access from a memory associated with the network access point 40) single-sided RTT measurement associated with the network access point 40 using the second scanning module. In an example, performing the second scan comprises sending a ranging request across the particular frequency channel associated with the network access point 40. The network access point 40 for the second scan may be selected based on the network access point information collected during the first scan and the set of predefined selection criteria.

In an example, the single-sided RTT measurement associated with the network access point 40 comprises a second signal strength value. For example, the second signal strength value associated with the network access point 40 may include a signal strength measurement, such as an RSSI measurement (referred to as RSSI2) for radio signal from the network access point 40.

At 310, the mobile apparatus 20 may be configured to transmit the network access point information associated with the plurality of available network access points and/or the network access point information associated with the network access point 40. Moreover, the mobile apparatus 20 may be configured to transmit the single-sided RTT measurement associated with the network access point 40 to the network apparatus 10.

It may be noted that the mobile apparatus 20 comprises different sources for performing radio measurements. For example, for performing radio measurements across Wi-Fi network interface, the mobile apparatus 20 may include Wi-Fi scanning module having throttling feature to restrict a frequency of Wi-Fi scanning for improving and prolonging the battery lifetime of the mobile apparatus 20. Further, for performing radio measurements across Wi-Fi network interface, the mobile apparatus 20 may also include the Wi-Fi single-sided RTT scanning module. Such examples of the sources for performing the radio measurements should not be construed as a limitation. In other examples, other complementary sources may be used for performing radio measurements across Wi-Fi interfaces and/or other communication interfaces.

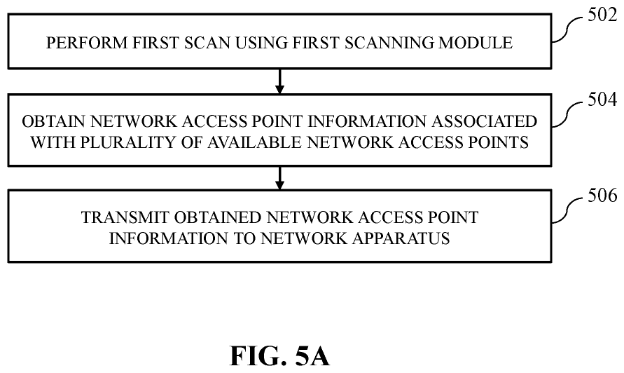

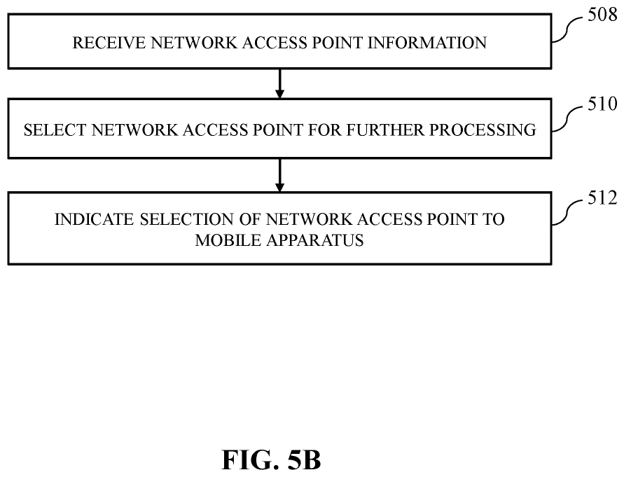

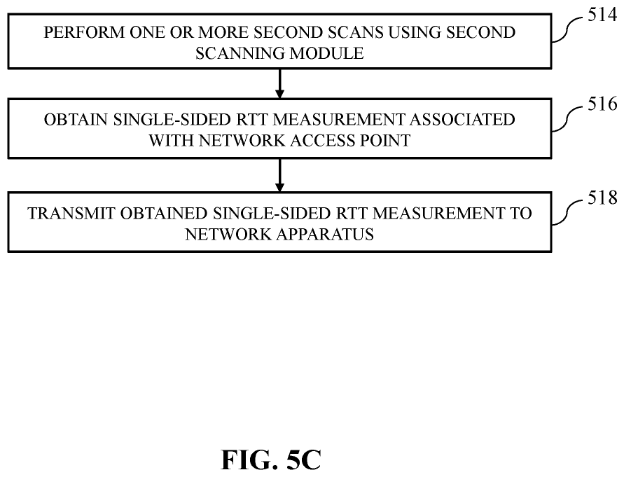

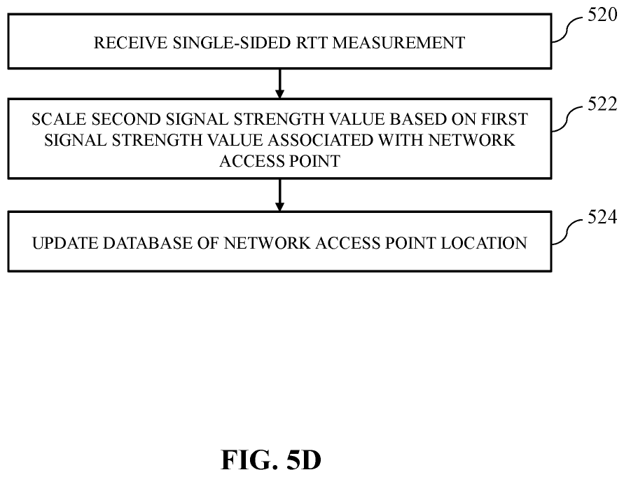

Pursuant to embodiments of the present disclosure, the network access point information and the single-sided RTT measurement associated with the network access point 40 may not be comparable. In particular, the first signal strength value (RSSI1) and the second signal strength value (RSSI2) may not be comparable. Therefore, these signal strength values may have to be scaled before using them for radio model generation and/or position determination. In this regard, the network apparatus 10 is configured to perform operations for scaling the first signal strength value (RSSI1) and the second signal strength value (RSSI2). Details of operations of the network apparatus 10 are described in conjunction with, for example, FIGS. 5B, 5D, 7, 8 and 9.

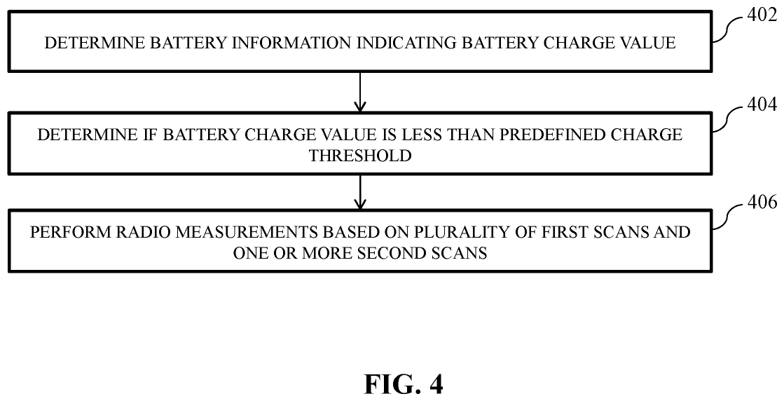

FIG. 4 provides a flowchart illustrating various processes, procedures, and/or operations performed by the mobile apparatus 20 for performing radio measurements based on battery information, according to an example embodiment.

Starting at step 402, the mobile apparatus 20 is configured to determine battery information of the mobile apparatus 20. The battery information indicates at least a battery charge value. For example, the battery charge value may be a percentage, a numerical value, a level, etc. The battery charge value may indicate a specific amount of battery charge that is left in the mobile apparatus 20. For example, the battery charge value may be a numerical value within a range of 0 to 10, where 0 indicates that the battery charge is used up or battery is completely discharged and 10 indicates that the battery charge is full, or the battery is completely charged. In another example, the battery charge value may be a percentage value within a range of 0 to 100, where 0% indicates that the battery charge is used up or battery is completely discharged and 100% indicates that the battery charge is full, or the battery is completely charged.

At step 404, the mobile apparatus 20 is configured to determine if the battery charge value is less than a predefined charge threshold. For example, if the battery charge value is less than the predefined charge threshold, the mobile apparatus may have to be operated in a power saver mode to conserve the battery charge. In an example, the predefined charge threshold for triggering the power saver mode on the mobile apparatus may be predefined and/or pre-set within the mobile apparatus. In an example, the predefined charge threshold may be a percentage, such as 20%, 15%, etc., or a numerical value, such as 4, 3, etc. To this end, a battery management module of the mobile apparatus 20 may initiate the power saver mode when the battery charge value reaches the predefined charge threshold and/or when the battery charge value is less than the predefined charge threshold.

At step 406, the mobile apparatus 20 is configured to perform the radio measurements based on the plurality of first scans and the one or more second scans. As may be understood, the plurality of first scans are performed using a first scanning module having a predefined throttling period, whereas the plurality of second scans are performed using a second scanning module. In an example, during the power saver mode, performing the radio measurements using different sources, i.e., the first scanning module and the second scanning module. may enable battery conservation of the mobile apparatus 20.

Pursuant to present example, performing the radio measurements using the different sources of radio measurements is triggered when the battery charge value of the mobile apparatus 20 is less than the predefined charge threshold. However, this should not be construed as a limitation. In another exemplary embodiment, performing the radio measurements using the different sources of radio measurements may be triggered based on a user input. For example, if a user of the mobile apparatus 20 may set the mobile apparatus 20 to a power saving mode to ensure longevity of battery charge, then the radio measurements may be performed using the different sources. A manner in which the mobile apparatus 20 collects the radio measurements using the first scanning module and the second scanning module is described in detail in conjunction with, for example, FIG. 3.

FIGS. 5A, 5B, 5C and 5D collectively illustrate a flowchart illustrating various processes, procedures, and/or operations performed, such as by the mobile apparatus 20 and the network apparatus 10, for updating a database of network access point location, according to an example embodiment.

Referring to FIG. 5A, at step 502, the mobile apparatus 20 is configured to perform a first scan using the first scanning module. In an example, the first scanning module may be a configured to perform the first scan based on the predefined throttling period, say once in every thirty seconds. For example, during the first scan, the mobile apparatus 20 may be configured to scan across a plurality of frequency channels associated with a plurality of network access points. During the first scan, the mobile apparatus 20 may be configured to identify a plurality of available network access points, for example, comprising the network access point 40, for the mobile apparatus 20.

At step 504, the mobile apparatus 20 is configured to obtain network access point information associated with the plurality of available network access points. For example, the network access point information may include identification data (e.g., MAC addresses, SSIDs, BSSIDs, etc.) and a first signal strength value (e.g., RSSI1 measurement of each of radio signals originating from each of the plurality of available network access points).

At step 506, the mobile apparatus 20 is configured to transmit the obtained network access point information associated with the plurality of available network access points to the network apparatus 10.

Turning to FIG. 5B, at step 508, the network apparatus 10 is configured to receive the network access point information associated with the plurality of available network access points.

At step 510, the network apparatus 10 is configured to select a network access point, say the network access point 40 from the plurality of available network access points for further processing. The network apparatus 10 may be configured to select the network access point 40 based on a set of predefined selection criteria and the received network access point information.

For example, the set of predefined selection criteria for selecting a network access point may include, but is not limited to, strength of signal from the plurality of available network access points during the first scan, last seen network access point from the plurality of available network access points during the first scan, a network access point from the plurality of available network access points that is not present in a current radio map or a database of network access point location.

Further, at step 512, the network apparatus 10 may be configured to indicate such selection of the network access point 40 to the mobile apparatus 20.

In an example embodiment, the mobile apparatus 20 may also be configured to perform such selection of one or more network access points from the plurality of available network access points after the first scan.

Further, referring to FIG. 5C, at step 514, the mobile apparatus 20 is configured to perform one or more second scans using the second scanning module. For example, the second scanning module may be configured to perform the one or more second scans after the first scan, such as in between two consecutive first scans. The second scanning module may be configured to perform each of the one or more second scans once in every predefined time period, say once in every one second. In an example. The second scanning module may be configured to perform the one or more second scans during the first time interval initiated by the first scan, such as a thirty second interval in which the first scanning module is not scanning or operating.

In an example, during a second scan, the mobile apparatus 20 may be configured to scan across a particular frequency channel associated with the selected network access point 40. During the second scan, the mobile apparatus 20 may be configured to send a ranging request to the selected network access point 40, for example, every second.

At step 516, the mobile apparatus 20 is configured to obtain single-sided RTT measurement associated with the network access point 40 after a second scan. For example, the single-sided RTT measurement may include a second signal strength value (e.g., RSSI2 measurement for radio signals originating from the network access point 40). It may be noted that as the one or more second scans may be performed in every second, the second signal strength value for each of the second scans may be changing.

At step 518, the mobile apparatus 20 is configured to transmit the obtained single-sided RTT measurement associated with the network access point 40 to the network apparatus 10.

Turning now to FIG. 5D, at step 520, the network apparatus 10 is configured to receive the single-sided RTT measurement. It may be noted that the single-sided RTT measurement includes the second signal strength value or RSSI2 for the network access point 40 at a time at which a corresponding second scan is performed.

At step 522, the network apparatus 10 is configured to scale the second signal strength value based on the first signal strength value corresponding to the network access point 40. In particular, the network apparatus 10 is configured to scale the second signal strength value (RSSI2) based on the first signal strength value (RSSI1) such that scaled RSSI2 can be associated with a same time value at which the RSSI1, i.e. the first scan is performed. In this manner, during a period of the first time interval when RSSI1 values are not available, i.e., the first scan is not being performed, the RSSI2 values obtained during period second scans are scaled. For scaling each of the RSSI2 values collected during the first time interval, a same point of time at which the RSSI1 value is obtained, i.e., the beginning of the first interval, may be used. To this end, the scaled RSSI2 values may be comparable with the RSSI1 value and may relate to the same time.

For example, for a particular iteration, the network apparatus 10 may be configured to receive the RSSI1 value after the first scan and at the beginning of the first interval. Further, the network apparatus 10 may be configured to receive one or more RSSI2 values after the one or more second scans that are performed after the first scan and before a subsequent first scan. Further, the network apparatus 10 may be configured to scale each of the RSSI2 values based on the RSSI1 value.

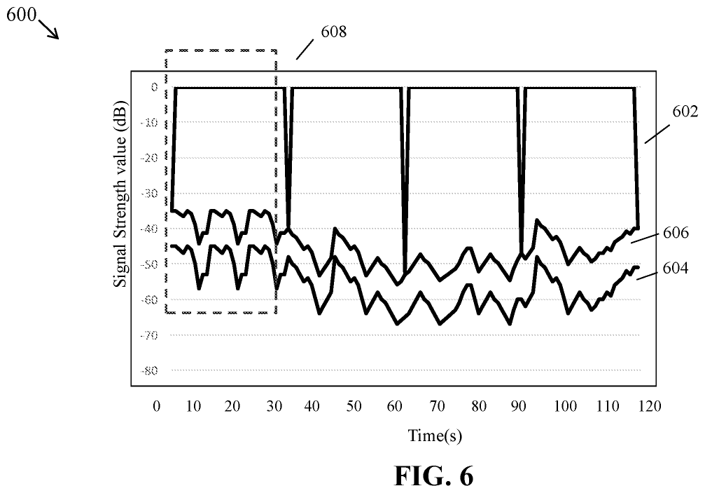

Referring to FIG. 6, there is shown a graphic representation 600 of scaling of a single-sided RTT measurement, according to an embodiment. There is shown a graph having a vertical axis and a horizontal axis. The vertical axis indicates signal strength in dB whereas the horizontal axis indicates time. For example, second signal strength (RSSI2) values obtained as part of the single-sided RTT measurement after the one or more second scans are scaled based on first signal strength values (RSSI1) obtained as part of the network access point information after the first scan.

Pursuant to the FIG. 6, the graphical representation 600 comprises a plot (a plotted line) 602 that shows first signal strength (RSSI1) values over a period of time. For example, the first signal strength (RSSI1) values may be obtained from first scans, for example, normal Wi-Fi scans. For example, such first scans are performed based on the predefined throttling period, such as once every thirty seconds. As may be seen, a spike in the first signal strength values is observed every 30 seconds. Subsequently, at a time at which an RSSI1 value is obtained may mark a beginning of a first time interval 608.

Further, the graphical representation 600 comprises a plot 604 that shows second signal strength (RSSI2) values over a period of time. In an example, the second signal strength (RSSI2) values may be obtained from second scans, for example, single-sided RTT scans. For example, one or more second scans may be performed between two consecutive first scans, such as within the first time interval 608. For example, if the first scans are performed once every 30 seconds, then the second scans may be performed once every one second within each 30 second period when the first scan is not being performed. To this end, the RSSI2 values need to be scaled to make them comparable with the RSSI1 values. Please note the graph shown in FIG. 6 is merely an example and may not be to exact scale.

In an example, for the first time interval 608 of 30 seconds between two first scans, the second scans may be performed 30 times to obtain 30 RSSI2 values. In order to scale a RSSI2 value from these 30 RSSI2 values, an RSSI1 value associated with the corresponding first time interval 608 is used. In this regard, the RSSI1 value at the beginning of the first time interval 608, say t0, is divided by the RSSI2 value of a second scan. The ratio is then multiplied by the same RSSI2 value of the second scan. This process may be repeated for each of the 30 RSSI2 values, corresponding to the first time interval 608.

In this manner, the RSSI2 values obtained after the multiple second scans are scaled. For example, the graphical representation 600 comprises another plot 606 that shows scaled RSSI2 values over the period of time. The scaled RSSI2 values may be used to fill gaps in, for example, Wi-Fi positioning technologies that may rely on, for example, Wi-Fi routers. Moreover, acquiring and scaling of the second signal strength values may not require any specialized sensors; thereby making such method of filling gap using scaled signal strength value obtained using single-sided RTT measurement practical, economical and accessible.

Returning back to FIG. 5D, at 524, the network apparatus 10 is configured to update a database of network access point location based on the scaled second signal strength values (scaled RSSI2 values). For example, updating the database of network access point location may comprise generating and/or updating a database or an entry associated with the network access point 40 within a current radio map. In an example, the database of network access point location may be a radio map associated with the network access point 40. Moreover, the radio map comprises one or more access point models associated with the network access point 40. In an example, based on the updated database of network access point location, more accurate radio model associated with the network access point 40 may be generated and used for position estimation by the mobile apparatus 20.

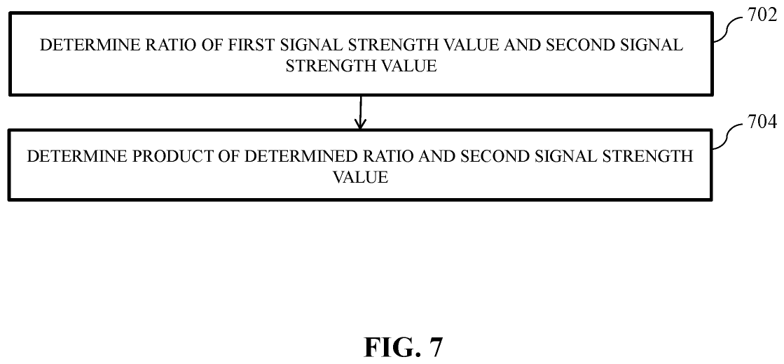

FIG. 7 is a flowchart illustrating various processes, procedures, and/or operations performed, such as by the network apparatus 10, for scaling single sided RTT measurements to update the database of network access point location, in accordance with an example embodiment. For example, the steps of the FIG. 7 may be performed at the step 522 of the FIG. 5D and as shown in FIG. 6.

Pursuant to present example, the network apparatus 10 is configured to scale a second signal strength or RSSI2 value of a single-sided RTT measurement obtained during a second scan in the first time interval based on a first signal strength or RSSI1 value of network access point information obtained during a first scan at the beginning of the first time interval. For example, the network access point information associated with the network access point 40 received after the first scan may include, but is not limited to, identification data (e.g. BSSID, SSID, MAC address, etc.) and a first signal strength value (e.g. detected signal level in dBm or an RSSI, say RSSI1). Further, the single-sided RTT measurement associated with the network access point 40 received after the second scan may include, but is not limited to, a second signal strength value (e.g., detected signal level in dBm or an RSSI measurement, say RSSI2).

At step 702, a ratio of the first signal strength value and the second signal strength value is determined. The ratio may be determined as RSSI1/RSSI2. It may be noted that the RSSI1 value may be obtained at the beginning of the first time interval for determining location information for the mobile apparatus 20.

At step 704, a product of the determined ratio and the second signal strength value is determined. In this regard, the ratio RSSI1/RSSI2 may be multiplied with RSSI2 to determine the scaled second signal strength value (say, Scaled RSSI2).

To this end, the scaled second signal strength value is determined as follows and is termed Formula 1:

$$ScaledRSSI 2 = RSSI 1 / RSSI 2 * RSSI 2$$

In an example, based on the scaled RSSI2 value, the database of network access point location may be updated to store the scaled RSSI2 value. Further, for example, the scaled RSSI2 value and the RSSI1 value may be comparable.

Based on the scaled RSSI2 value and the RSSI1 value, a radio map of the network access point 40 may be updated accurately. Moreover, a radio model generated using the scaled RSSI2 value and the RSSI1 value is accurate owing to continuity and improved quality of radio measurements from the mobile apparatus 20.

Subsequently, in an example, the network apparatus 10 may be configured to generate the radio model for the network access point 40 based on the scaled RSSI2 value of the network access point and the RSSI1 value. To this end, the network apparatus 10 may be configured to transmit the radio model for the network access point 40 to the mobile apparatus for position estimation.

For example, using the radio model and/or the updated database of network access point location associated with the network access point 40, the network apparatus 10 may cause the mobile apparatus 20 to estimate location information. In an example, the mobile apparatus 20 may estimate the location information for the first time interval initiated by the first scan corresponding to, for example, thirty seconds.

According to various embodiments, a network positioning system of the mobile apparatus 20 may utilize the radio model for the network access point 40 in position or location information determination. In an example, the radio model (e.g., model of radio coverage area, radio signal propagation, signal strength, Rx field, etc.) of the network access point 40 may indicate a mapping relationship between a parameter of the network access point 40 and location or distance from the network access point 40. For example, network positioning system may use radio network access point location, radio network access point coverage area and/or signal strength map of the network access point 40 to determine an estimate of location information of the mobile apparatus 20.

In accordance with an example, the network apparatus 10 may further be configured to generate navigation instructions for a vehicle and/or a user associated with the mobile apparatus 20 based on the estimated location information.

Typically, RTT measurement for Wi-Fi network interfaces may be collected using standard IEEE 802.11. This allows computing devices to measure a distance to nearby Wi-Fi access points (WAPs). The RTT measurement may be used to determine device location with a precision of few meters using round trip delay between user devices and the WAPs. However, transmission of Wi-Fi RTT measurement is supported by only a few Wi-Fi access points and thus is not in practice usable for positioning technologies.

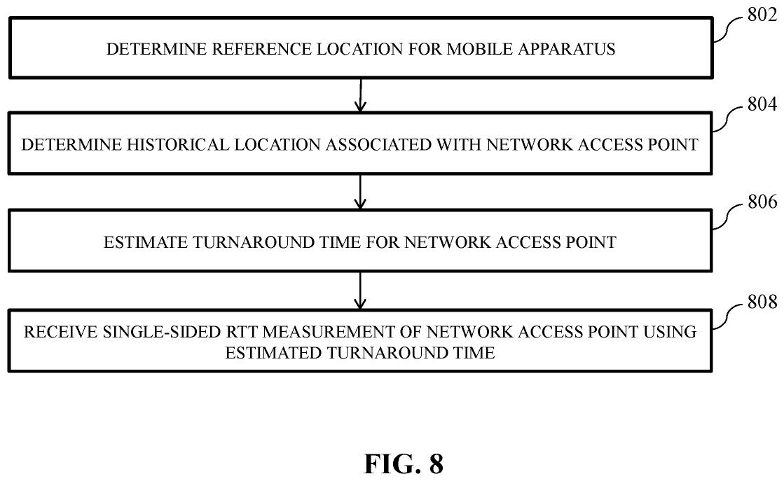

Conventional technologies also include collecting single-sided RTT measurements from Wi-Fi access points. In the single-sided RTT measurements roles of mobile apparatuses and WAPs may be conceptually reversed. In particular, a mobile apparatus may send a ping to a WAP, say at t1, and the WAP receives the ping, say at t2. Further, the WAP sends RTT measurements to the mobile apparatus, say at t3, which may be received by the mobile apparatus, say at t4. In this regard, a turn-around time between t2 and t3 for the WAP, say the network access point 40, remains unknown. As a result, distance estimate between the mobile apparatus 20 and the network access point 40 determined based on the single-sided RTT measurements may have much larger bias compared to those estimated with two-sided RTT. To overcome the drawback due to unknown turnaround time associated with single-sided RTT measurement collected by the mobile apparatus 20, the steps of the FIG. 8 may be performed.

FIG. 8 is a flowchart illustrating operations performed, such as by the network apparatus 10, for receiving single sided RTT measurements, according to an example embodiment.

At step 802, the network apparatus 10 is configured to determine a reference location for the mobile apparatus 20. For example, the reference location for the mobile apparatus 20 may be determined based on global navigation satellite system (GNSS) or sensor fusion.

At step 804, the network apparatus 10 is configured to estimate a historical location associated with the network access point 40. In an example, the historical location for the network access point 40 may be estimated based on traditional network positioning system, such as based on received signal strength maps, two-sided RTT range measurement maps, and/or single-sided RTT range measurement maps. For example, for Wi-Fi based network access points, the historical locations may be estimated based on maps for loop closure in HD Wi-Fi system.

At step 806, the network apparatus 10 is configured to estimate a turnaround time for the network access point 40 based on the reference location, the historical location and a timestamp associated with a ranging request for single-sided RTT measurement during a second scan. As may be noted, the turnaround time is a time period that the network access point 40 takes to send the single-sided RTT measurement after receiving the ranging request.

In this regard, the network apparatus 10 may be configured to estimate a distance between the mobile apparatus 20 and the network access point 40 based on the reference location and the historical location. Further, a time at which the ranging request may be sent during a second scan may correspond to t1, while a time at which the single-sided RTT measurement is received may correspond to t4.

According to various embodiments, the network apparatus 10 may be configured to subtract an estimated time that a radio signal may take to travel the distance between the mobile apparatus 20 and the network access point 40 from an overall roundtrip time in order to resolve the unknown turnaround time for the network access point 40. For example, the turnaround time may be estimated, based on the identified values of t1, t3 and t4, as follows and is termed Formula 2:

$$t 3 - t 2 = ( t 4 - t 1 ) - 2 * ( t 4 - t 3 )$$

where t4−t3 is estimated as d/C, where d is the estimated distance between the mobile apparatus 20 and the network access point 40 computed based on the reference location of the mobile apparatus 20 and the historical location of the network access point 40, and C is the speed of light.

At step 808, the network apparatus 10 is configured to receive the single-sided RTT measurement associated with the network access point 40 using the estimated turnaround time (t3−t2) for the network access point 40.

In this regard, the network apparatus 10 is configured to use the turnaround time to determine a location of the network access point 40 accurately. Further, using accurate location of the network access point 40, the single sided RTT measurement, specifically, the RSSI2 value obtained as part of the single sided RTT measurement may be accurate.

According to an example, the network apparatus 10 may be configured to estimate a final turnaround time for the network access point 40 based on multiple measurements, e.g. as an average of multiple turnaround measurements based on multiple reference locations of multiple apparatuses and different historical locations of the network access point 40.

In one example, the mobile apparatus 20 may be configured to estimate the turnaround time for the network access point 40 and transmit the estimated turnaround time as a part of crowd sourced radio measurements to the network apparatus 10.

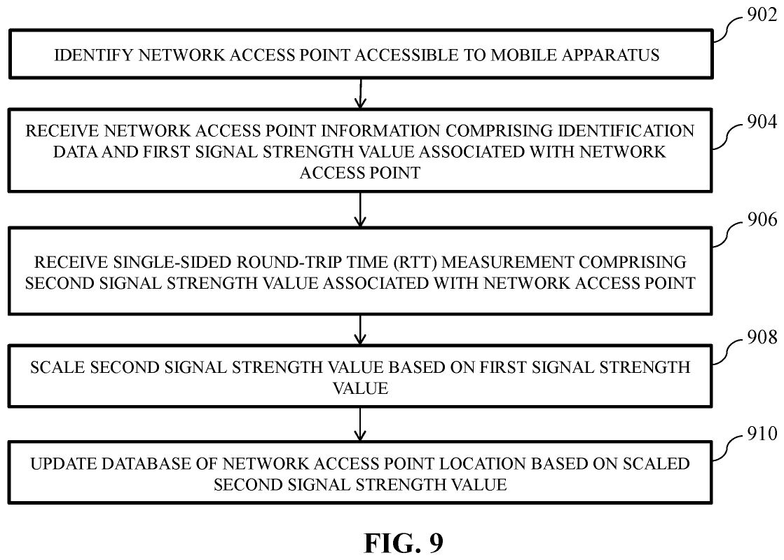

FIG. 9 is a flowchart illustrating operations performed, such as by the network apparatus 10, for updating the database of network access point location, according to an example embodiment.

At step 902, the network apparatus 10 may be configured to identify the network access point 40 accessible to the mobile apparatus 20. In an example, the radio network apparatus 10 may identify the network access point 40 accessible to the mobile apparatus 20 based on the set of predefined selection criteria and a first scan performed by the first scanning module or a Wi-Fi scanning module across a plurality of frequency channels.

At step 904, the network apparatus 10 may be configured to receive network access point information associated with the network access point 40. The network access point information comprises identification data (for example, BSSID) and a first signal strength value (for example an RSSI measurements, namely, RSSI1). The network apparatus 10 may receive the network access point information from the mobile apparatus 20.

At step 906, the network apparatus 10 may be configured to receive a single-sided RTT measurement associated with the network access point 40. For example, based on the selection of the network access point 40, such as, based on signal strength, proximity, radio map, etc., the mobile apparatus 20 may perform second scan using a second scanning module or a Wi-Fi single-sided RTT scanning module. During the second scan, the second scanning module or a Wi-Fi single-sided RTT scanning module may send a ranging request to the network access point 40 for receiving the single-sided RTT measurement. In an example, the single-sided RTT measurement comprises a second signal strength value (for example an RSSI measurements, namely, RSSI2).

In an example, the network access point information and the single-sided RTT measurement are received for a first time interval that is initiated based on the first scan for obtaining the network access point information

At step 908, the network apparatus 10 may be configured to scale the second signal strength (RSSI2) value based on the first signal strength (RSSI1) value. Details of scaling the second signal strength (RSSI2) value are provided in conjunction with, for example, FIGS. 6 and 7.

In an example, certain alternative methods may be used for scaling. For example, a difference between the RSSI1 and the RSSI2 may be managed as a constant offset. Such constant offset may be denoted as Formula 3:

$$FixedRSSI 2 = RSSI 1 - RSSI 2 + RSSI 2$$

According to an embodiment, if RSSI1 is a linear function of RSSI2, the RSSI1 may be denoted as Formula 4:

$$RSSI 1 = a * RSSI 2 + b$$

Where a denotes scale and b denotes offset. Both scale, a, and offset, b, may be estimated using linear regression method. It may be noted that multiple pairs of <RSSI1, RSSI2> may be measured at multiple times, such as in a same iteration or in different iterations. Additionally, multiple data points of the form <RSSI1, RSSI2> can be collected by multiple mobile apparatuses, and values of the scale, a, and the offset, b, for the network access point 40 may be estimated.

In an example, non-linear mapping between RSSI1 and RSSI2 for the network access point 40 may be estimated based on the data points <RSSI1, RSSI2> stored in the database of network access point location (radio map) for a positioning use.

At step 910, the network apparatus 10 may be configured to update the database of network access point location based on the scaled RSSI2 value. In an example, the database of network access point location is a radio map associated with the network access point 40. Further, the radio map may store one or more access point models associated with the network access point 40.

Various embodiments provide improvements to the fields of radio map generation and radio-based positioning. The database of network access point location may be used to generate accurate radio models of network access points for use in position estimation. Therefore, various embodiments provide improved user experience and improved computer apparatus performance.

Various embodiments provide improvements in terms of power savings for mobile apparatuses by using different sources for performing radio measurements. For example, single-sided RTT measurements may be performed using single-sided RTT scanning modules that may use less power than traditional scanning modules. For positioning use it may be enough to scan only the closest access point, i.e., use less power to measure closest access point. In contrast, the traditional scanning modules, especially in case of poor network coverage may have to scan a whole band when searching for a network connection. In this manner, by using both the single-sided RTT scanning modules and the traditional scanning modules intermittently, positioning of the mobile apparatuses may be performed accurately.

Due to better control of scanning, such as Wi-Fi scanning or cellular scanning, power saving in the mobile apparatuses may be achieved. Such better control of scanning is possible because of, for example, (a) need to measure only nearby access points, and (b) possibility to include a desired access point for single-sided RTT measurements. For example, embodiments to include only a last seen access point for performing single-sided RTT measurements raises a likelihood for not to scan too long for the access points that are not in the range anymore.

In an example embodiment, only last seen, such as ten last seen access points, criteria may be used for performing radio measurements, i.e., scanning to collect measurements for only the ten last seen access points based on their corresponding frequency channels. For example, if all of the ten last seen access points are found, it may be assumed that they are found using only 50% of power compared to traditional scanning result. This is due to the fact that only a portion of access points that may be available to the mobile apparatuses may be searched. Moreover, it may be assumed that every fifth time of a normal scan, one of the ten last seen access point cannot be reached anymore, and the scan takes as long as a normal scan. Thus, various embodiments may enable power saving of the mobile apparatuses while performing continuous scans for access points.

Due to continuous scans for the access points, more radio measurements may be input for learning radio model and more frequent positioning estimation may be performed. This may improve positioning quality for the network positioning system.

For example, for non-IoT devices, instead of performing single-sided RTT scans, some other operating software (OS) specific scan may be performed to collect radio measurements.

The network apparatus 10, mobile apparatus 20, and/or computing apparatus 30 of an example embodiment may be embodied by or associated with a variety of computing devices including, for example, a navigation system including a global navigation satellite system (GNSS), a cellular telephone, a mobile phone, a personal digital assistant (PDA), a watch, a camera, a computer, an Internet of things (IoT) item, and/or other device that can observe an environment (e.g., a radio environment such as radio frequency signals from the network access points 40, and/or the like) in the vicinity of the computing device. Additionally or alternatively, the network apparatus 10, mobile apparatus 20, and/or computing apparatus 30 may be embodied in other types of computing devices, such as a server, a personal computer, a computer workstation, a laptop computer, a plurality of networked computing devices or the like, that are configured to capture and provide instances of crowd-sourced data, update map data based on instances of crowd-sourced data, and/or the like. In an example embodiment, a mobile apparatus 20 and/or a computing apparatus 30 are a smartphone, tablet, laptop, PDA, and/or other mobile computing device and a network apparatus 10 is a server that may be part of a Cloud-based computing asset and/or processing system.

In some embodiments, the processor 12, and 22 (and/or co-processors or any other processing circuitry assisting or otherwise associated with the processor) may be in communication with the memory device 14 and 24 via a bus for passing information among components of the apparatus. The memory device may be non-transitory and may include, for example, one or more volatile and/or non-volatile memories. In other words, for example, the memory device may be an electronic storage device (e.g., a non-transitory computer readable storage medium) comprising gates configured to store data (e.g., bits) that may be retrievable by a machine (e.g., a computing device like the processor). The memory device may be configured to store information, data, content, applications, instructions, or the like for enabling the apparatus to conduct various functions in accordance with an example embodiment of the present invention. For example, the memory device could be configured to buffer input data for processing by the processor. Additionally, or alternatively, the memory device could be configured to store instructions for execution by the processor.

As described above, the network apparatus 10, mobile apparatus 20, and/or computing apparatus 30 may be embodied by a computing entity and/or device. However, in some embodiments, the network apparatus 10, mobile apparatus 20, and/or computing apparatus 30 may be embodied as a chip or chip set. In other words, the network apparatus 10, mobile apparatus 20, and/or computing apparatus 30 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute a means for performing one or more operations for providing the functionalities described herein.

The processors 12 and 22 may be embodied in a number of different ways. For example, the processor 12 and 22 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processors 12 and 22 may include one or more processing cores configured to perform independently. A multi-core processor may enable multiprocessing within a single physical package. Additionally, or alternatively, the processors 12 and 22 may include one or more processors configured in tandem via the bus to enable independent execution of instructions, pipelining and/or multithreading.

In an example embodiment, the processor 12 and 22 may be configured to execute instructions stored in the memory device 14 and 24 or otherwise accessible to the processor. Alternatively, or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the network apparatus 10, mobile apparatus 20, and/or computing apparatus 30 may include a user interface 18 and 28 that may, in turn, be in communication with the processor 12 and 22 to provide output to the user, such as one or more navigable routes to a destination location and/or from an origin location, display of location dependent and/or triggered information, and/or the like, and, in some embodiments, to receive an indication of a user input. As such, the user interface 18 and 28 may include one or more output devices such as a display, speaker, and/or the like and, in some embodiments, may also include one or more input devices such as a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor 12 and 22 (e.g., memory device 14 and 24 and/or the like).

The network apparatus 10, mobile apparatus 20, and/or computing apparatus 30 may optionally include a communication interface 16 and 26. The communication interface 16 and 26 may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally, or alternatively, the communication interface may include the circuitry for interacting with the antenna(s) to cause transmission of signals via the antenna(s) or to manage receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

In various embodiments, a network apparatus 10, mobile apparatus 20, and/or computing apparatus 30 may comprise a component (e.g., memory 14 and 24, and/or another component) that stores a digital map (e.g., in the form of a geographic database) comprising a first plurality of data records, each of the first plurality of data records representing a corresponding traversable map element (TME). At least some of said first plurality of data records map information/data indicates current traffic conditions along the corresponding TME. For example, the geographic database may include a variety of data (e.g., map information/data) utilized in various navigation functions such as constructing a route or navigation path, determining the time to traverse the route or navigation path, matching a geolocation (e.g., a GNSS determined location, a radio-based position estimate) to a point on a map, a lane of a lane network, and/or link, one or more localization features and a corresponding location of each localization feature, and/or the like. For example, the geographic database may comprise a positioning map comprising an access point registry and/or instances of network access point information corresponding to various network access points. For example, a geographic database may include road segment, segment, link, lane segment, or TME data records, point of interest (POI) data records, localization feature data records, and other data records. More, fewer or different data records can be provided. In one embodiment, the other data records include cartographic (“carto”) data records, routing data, and maneuver data. One or more portions, components, areas, layers, features, text, and/or symbols of the POI or event data can be stored in, linked to, and/or associated with one or more of these data records. For example, one or more portions of the POI, event data, or recorded route information can be matched with respective map or geographic records via position or GNSS data associations (such as using known or future map matching or geo-coding techniques), for example. In an example embodiment, the data records may comprise nodes, connection information/data, intersection data records, link data records, POI data records, and/or other data records. In an example embodiment, the network apparatus 10 may be configured to modify, update, and/or the like one or more data records of the geographic database. For example, the network apparatus 10 may modify, update, generate, and/or the like map information/data corresponding to TMEs, links, lanes, road segments, travel lanes of road segments, nodes, intersection, pedestrian walkways, elevators, staircases, network access points 40 or other observable features, and/or the like and/or the corresponding data records (e.g., to add or update updated map information/data including, for example, current traffic conditions along a corresponding TME; assign and/or associate an access point with a TME, lateral side of a TME, and/or representation of a building; and/or the like), a localization layer (e.g., comprising localization features), a registry of access points to identify mobile access points, and/or the corresponding data records, and/or the like.

In an example embodiment, the TME data records are links, lanes, or segments (e.g., maneuvers of a maneuver graph, representing roads, travel lanes of roads, streets, paths, navigable aerial route segments, and/or the like as can be used in the calculated route or recorded route information for determination of one or more personalized routes). The intersection data records are ending points corresponding to the respective links, lanes, or segments of the TME data records. The TME data records and the intersection data records represent a road network and/or other traversable network, such as used by vehicles, cars, bicycles, and/or other entities. Alternatively, the geographic database can contain path segment and intersection data records or nodes and connection information/data or other data that represent pedestrian paths or areas in addition to or instead of the vehicle road record data, for example. Alternatively, and/or additionally, the geographic database can contain navigable aerial route segments or nodes and connection information/data or other data that represent a navigable aerial network, for example.

The TMEs, lane/road/link/path segments, segments, intersections, and/or nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database can include data about the POIs and their respective locations in the POI data records. The geographic database can also include data about places, such as cities, towns, or other communities, and other geographic features, such as bodies of water, mountain ranges, etc. Such place or feature data can be part of the POI data or can be associated with POIs or POI data records (such as a data point used for displaying or representing a position of a city). In addition, the geographic database can include and/or be associated with event data (e.g., traffic incidents, constructions, scheduled events, unscheduled events, etc.) associated with the POI data records or other records of the geographic database.

In various embodiments, the digital map is and/or comprises a radio map. The radio map is configured to describe the radio environment at various points within a corresponding geographical area and/or region. For example, the radio map may comprise a plurality of radio models where each radio model models, describes, and/or characterizes a respective coverage area of a respective radio network access point. In various embodiments, the radio models of the radio map are generated and/or updated based on crowd-sourced data, such as observation data and/or radio fingerprints, provided by various mobile apparatus 20 and/or computing apparatus 30. For example, a radio map may be stored as part of a geographic database.

The geographic database can be maintained by the content provider (e.g., a map developer) in association with the services platform. By way of example, the map developer can collect geographic data to generate and enhance the geographic database. There can be different ways used by the map developer to collect data. These ways can include obtaining data from other sources, such as municipalities or respective geographic authorities. In addition, the map developer can employ field personnel to travel by vehicle along roads throughout the geographic region to observe features and/or record information about them, for example. Also, remote sensing, such as aerial or satellite photography, can be used.

The geographic database can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions. The navigation-related functions can correspond to vehicle navigation or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

As described above, FIGS. 3, 4, 5A, 5B, 5C, 5D, 6, 7, 8 and 9 illustrate flowcharts of a network apparatus 10, mobile apparatus 20, and/or computing apparatus 30, methods, and computer program products according to an example embodiment of the invention. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 14 and 24 of an apparatus employing an embodiment of the present invention and executed by the processor 12 and 22 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
identifying, by a network apparatus, a network access point accessible to a mobile apparatus;
receiving, by the network apparatus, network access point information associated with the network access point, wherein the network access point information comprises at least identification data and a first signal strength value;
receiving, by the network apparatus, a single-sided round-trip time (RTT) measurement associated with the network access point, wherein the single-sided RTT measurement comprises at least a second signal strength value;
scaling, by the network apparatus, the second signal strength value based on the first signal strength value, wherein each of the first signal strength value and the second signal strength value comprises at least a received signal strength indicator (RSSI) measurement; and
updating, by the network apparatus, a database of network access point location based on the scaled second signal strength value.

2. The method of claim 1, further comprising:
receiving, by the network apparatus, the network access point information at a beginning of a first time interval;
receiving, by the network apparatus, the single-sided round-trip time (RTT) measurement associated with the network access point during the first time interval; and
determining, by the network apparatus, location information for the mobile apparatus during the first time interval based on the network access point information and the single-sided RTT measurement.

3. The method of claim 1, wherein scaling the second signal strength value further comprises:
determining, by the network apparatus, a ratio of the first signal strength value and the second signal strength value; and
determining, by the network apparatus, a product of the determined ratio and the second signal strength value.

4. The method of claim 1, further comprising:
generating, by the network apparatus, a radio model for the network access point based on the scaled second signal strength value and the first signal strength value of the network access point; and
transmitting, by the network apparatus, the radio model to the mobile apparatus for position estimation.

5. The method of claim 4, further comprising:
causing, by the network apparatus, the mobile apparatus to estimate location information based on at least one of: the radio model, or the updated database of network access point location.

6. The method of claim 1, wherein identifying the network access point further comprises:
causing to perform, by the network apparatus using a first scanning module of the mobile apparatus, a first scan across a plurality of frequency channels to identify the network access point accessible to the mobile apparatus.

7. The method of claim 6, wherein receiving the single-sided RTT measurement further comprises:
causing to perform, by the network apparatus using a second scanning module of the mobile apparatus, a second scan for the network access point after the first scan, wherein the second scan comprises sending a ranging request across a frequency channel associated with the network access point; and
receiving, by the network apparatus, the single-sided RTT measurement associated with the network access point based on the ranging request.

8. The method of claim 7, wherein the method further comprises:
determining, by the network apparatus, a reference location for the mobile apparatus;
estimating, by the network apparatus, a historical location associated with the network access point;
estimating, by the network apparatus, a turnaround time for the network access point based on the reference location, the historical location and a time value associated with the ranging request for the single-sided RTT measurement; and
receiving, by the network apparatus, the single-sided RTT measurement associated with the network access point based at least in part on the estimated turnaround time for the network access point.

9. The method of claim 7, further comprising:
causing to perform, by the network apparatus, the first scan using a Wi-Fi scanning module of the mobile apparatus, wherein the Wi-Fi scanning module is configured to perform the first scan based on a predefined throttling period; and
causing to perform, by the network apparatus, the second scan using a Wi-Fi single-sided RTT scanning module, wherein the Wi-Fi single-sided RTT scanning module is configured to send the ranging request based on a predefined ranging period, and wherein the predefined ranging period is less than the predefined throttling period.

10. The method of claim 7, further comprising:
causing to perform, by the network apparatus using the first scanning module, a plurality of first scans based on a predefined throttling period, wherein the plurality of first scans comprises the first scan performed across the plurality of frequency channels to identify the network access point; and
causing to perform, by the network apparatus using the second scanning module, one or more second scans across the frequency channel associated with the network access point, wherein the one or more second scans are performed between two consecutive first scans from the plurality of first scans, and wherein each of the one or more second scans is performed once in every predefined time period, and wherein the predefined time period lies within the predefined throttling period.

11. The method of claim 10, further comprising:
causing, by the network apparatus, the mobile apparatus to determine battery information of the mobile apparatus, the battery information indicating at least a battery charge value; and
based on a determination of the battery charge value to be less than a predefined charge threshold, causing, by the network apparatus, the mobile apparatus to perform radio measurements based on the plurality of first scans and the one or more second scans.

12. The method of claim 1, further comprising:
identifying, by the network apparatus, a plurality of available network access points accessible to the mobile apparatus, wherein the plurality of available network access points comprise the network access point;
receiving, by the network apparatus, network access point information associated with each of the plurality of available network access points, wherein the network access point information comprises at least: identification data and first signal strength value data;
selecting, by the network apparatus, the network access point for the mobile apparatus based on a set of predefined selection criteria; and
after selection, receiving, by the network apparatus, the single-sided RTT measurement associated with the network access point.

13. The method of claim 1, wherein the database of network access point location is a radio map associated with the network access point, and wherein the radio map comprises one or more access point models associated with the network access point.

14. An apparatus comprising at least one processor and at least one memory storing computer program code and/or instructions, the at least one memory and the computer program code is configured to, with the processor, cause the apparatus to at least:
identify a network access point accessible to a mobile apparatus;
receive network access point information associated with the network access point, wherein the network access point information comprises at least: identification data and a first signal strength value;
receive a single-sided round-trip time (RTT) measurement associated with the network access point, wherein the single-sided RTT measurement comprises at least a second signal strength value;
scale the second signal strength value based on the first signal strength value, wherein each of the first signal strength value and the second signal strength value comprises at least a received signal strength indicator (RSSI) measurement; and
update a database of network access point location based on the scaled second signal strength value.

15. The apparatus of claim 14, wherein the at least one memory and the computer program code is configured to, with the processor, further cause the apparatus to at least:
determine a ratio of the first signal strength value and the second signal strength value; and
determine a product of the determined ratio and the second signal strength value.

16. The apparatus of claim 14, wherein the at least one memory and the computer program code is configured to, with the processor, further cause the apparatus to at least:
generate a radio model for the network access point based on the scaled second signal strength value and the first signal strength value of the network access point; and
transmit the radio model to the mobile apparatus for position estimation.

17. The apparatus of claim 14, wherein the at least one memory and the computer program code is configured to, with the processor, further cause the apparatus to at least:
cause to perform, using a first scanning module of the mobile apparatus, a first scan across a plurality of frequency channels;
identify a plurality of available network access points accessible to the mobile apparatus, wherein the plurality of available network access points comprises the network access point;
receive network access point information associated with each of the plurality of available network access points, wherein the network access point information comprises at least: identification data and first signal strength value data;
select the network access point for the mobile apparatus based on a set of predefined selection criteria;
cause to perform, using a second scanning module of the mobile apparatus, a second scan for the network access point after the first scan, wherein the second scan comprises sending a ranging request across a frequency channel associated with the network access point; and
receive the single-sided RTT measurement associated with the network access point based on the ranging request.

18. The apparatus of claim 17, wherein the at least one memory and the computer program code is configured to, with the processor, further cause the apparatus to at least:
cause to perform the first scan using a Wi-Fi scanning module of the mobile apparatus, wherein the Wi-Fi scanning module is configured to perform the first scan based on a predefined throttling period; and
cause to perform the second scan using a Wi-Fi single-sided RTT scanning module, wherein the Wi-Fi single-sided RTT scanning module is configured to send the ranging request based on a predefined ranging period, and wherein the predefined ranging period is less than the predefined throttling period.

19. The apparatus of claim 17, wherein the at least one memory and the computer program code is configured to, with the processor, further cause the apparatus to at least:
cause to perform, using the first scanning module, a plurality of first scans based on a predefined throttling period, wherein the plurality of first scans comprises the first scan performed across the plurality of frequency channels to identify the network access point; and
cause to perform, using the second scanning module, one or more second scans across the frequency channel associated with the network access point, wherein the one or more second scans are performed between two consecutive first scans from the plurality of first scans, and wherein each of the one or more second scans is performed once in every predefined time period, and wherein the predefined time period lies within the predefined throttling period.

20. The apparatus of claim 19, wherein the at least one memory and the computer program code is configured to, with the processor, further cause the apparatus to at least:
cause the mobile apparatus to determine battery information of the mobile apparatus, the battery information indicating at least a battery charge value; and
cause the mobile apparatus to perform radio measurements based on the plurality of first scans and the one or more second scans based on determination of the battery charge value to be less than a predefined charge threshold.
